(19) United States
(12) Patent Application Publication
(10) Pub. No.: US 2007/0050668 A1
(43) Pub. Date: Mar. 1, 2007

(54) Test mode to force generation of all possible correction codes in an ECC memory

(75) Inventor: Dean Gans, Nampa, ID (US)

Correspondence Address: JONES DAY, 500 GRANT STREET, SUITE 3100, PITTSBURGH, PA, 15219-2502, US

(73) Assignee: Micron Technology, Inc.

(21) Appl. No.: 11/218,193

(22) Filed: Sep. 1, 2005

(51) Int. Cl. G06F 11/00

(52) U.S. Cl. 714/6

(57) ABSTRACT

The present disclosure enables individual bits of a data signal to be flipped (their state changed from logic one to logic zero or vice versa) to mimic an error. By flipping various bits or combinations of bits, various predetermined errors can be forced. By measuring the time delay between when uncorrected data is output from the memory device and when corrected data is output, the time the error correction circuitry takes to correct each of the forced errors can be measured and the part characterized according to the various measurements. Because of the rules governing abstracts, this abstract should not be used to construe the claims.

### BACKGROUND OF THE INVENTION

The present disclosure is directed generally to test modes and, more particularly, to test modes used in connection with error correction codes.

It is known in the prior art to conduct tests of memory devices to insure that the part is good. Such tests typically comprise generating a test pattern, writing the test pattern to the memory array, reading the written test pattern, and comparing the written test pattern with the read test pattern. Comparison of the aforementioned two test patterns will identify any memory locations in the array which are malfunctioning.

In addition to the kind of test previously described, other types of tests are performed on parts, particularly new parts, for the purpose of characterizing the part. After the part has been characterized, the test may be performed randomly on various numbers of parts to insure that each batch or lot of parts continues to meet the established parameters for the part.

### BRIEF SUMMARY OF THE INVENTION

The present disclosure provides a method and apparatus for quickly characterizing an aspect of a memory device, i.e., to characterize the time needed to correct a worst case data error with onboard error correcting circuitry. Individual bits can be flipped (their state changed from logic 1 to logic zero or vice versa) to mimic an error by forcing the test data to the state corresponding to the bit desired to be flipped. By flipping various bits or combinations of bits, various predetermined errors can be forced. By measuring the time delay between when uncorrected data is output from the memory device and when corrected data is output, the time the error correction circuitry takes to correct each of the forced errors can be measured and the part characterized according to the various measurements.

One aspect of the present disclosure is directed to a method of forcing errors in received test data. According to another aspect of the present disclosure, the errors may be forced in the data prior to sending the data to the part to be tested. The errors are forced by manipulating at least one bit of the test data or error correction data to produce a predetermined error. All of the errors capable of being corrected by the error correction data may be forced. The data, including the forced error(s), is written to an array.

Another aspect of the present disclosure is directed to characterizing an output delay of a memory device. By reading the data generated as described above, the read data can be output. The read data can also be processed by error correction circuitry to produce corrected data which is output. The output delay of the part can be characterized by measuring the time between when the read data is output and when the corrected data is output.

Another aspect of the present disclosure is directed to a memory device comprising an array of memory cells and a plurality of peripheral devices for reading data from and writing data to the memory cells. The peripheral devices comprise a decode circuit, an error correction data generator, responsive to test data, for producing error correction data, a first circuit, responsive to the decode circuit, for receiving the test data and the error correction data and for manipulating at least one bit of the received data to produce a predetermined error, and an error correction circuit for receiving test data and error correction data read from the memory array. The error correction circuit corrects the test data read from the memory array. The memory device may be used in various systems.

### BRIEF DESCRIPTION OF THE DRAWINGS

For the present invention to be easily understood and readily practiced, the present invention will now be described, for purposes of illustration and not limitation, in conjunction with the following figures, wherein:

FIG. 1 is a simplified block diagram of a memory device;

FIG. 2 is a schematic diagram illustrating a combination of circuits according to one aspect of the present invention:

FIG. 3 illustrates the details of the four to sixteen decode circuit of FIG. 2;

FIG. 4 illustrates the details of the di live generator circuit of FIG. 2;

FIG. 5 illustrates the details of the di parity generator circuit of FIG. 2;

FIG. 6 illustrates a data path for read (uncorrected) data;

FIG. 7 illustrates an error correction path for interrupt signals; and

FIG. 8 is a simplified block diagram of a system in which a memory device constructed according to the teachings of the present disclosure may be used.

### DETAILED DESCRIPTION OF THE INVENTION

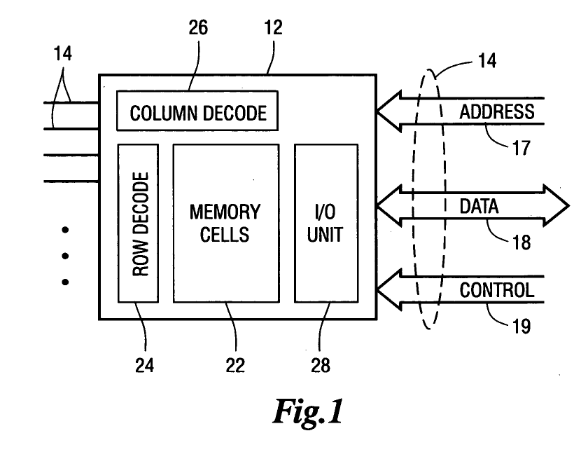

Memory devices are electronic devices that are widely used in many electronic products and computers to store data. A memory device is a semiconductor electronic device that includes a number of memory cells, each cell storing one bit of data. The data stored in the memory cells can be read during a read operation. FIG. 1 is a simplified block diagram showing a memory chip or memory device 12. The memory chip 12 may be part of a DIMM (dual in-line memory module) or a PCB (printed circuit board) containing many such memory chips (not shown in FIG. 1). The memory chip 12 may include a plurality of pins or ball contacts 14 located outside of chip 12 for electrically connecting the chip 12 to other system devices. Some of those pins 14 may constitute memory address pins or address bus 17, data (DQ) pins or data bus 18, and control pins or control bus 19. It is evident that each of the reference numerals 17-19 designates more than one pin in the corresponding bus. Further, it is understood that the schematic in FIG. 1 is for illustration only. That is, the pin arrangement or configuration in a typical memory chip may not be in the form shown in FIG. 1.

A processor or memory controller (not shown) may communicate with the chip 12 and perform memory read/write operations. The processor and the memory chip 12 may communicate using address signals on the address lines or address bus 17, data signals on the data lines or data bus 18, and control signals (e.g., a row address strobe (RAS), a column address strobe (CAS), a chip select (CS) signal, etc. (not shown)) on the control lines or control bus 19. The “width” (i.e., number of pins) of address, data and control buses may differ from one memory configuration to another.

Those of ordinary skill in the art will readily recognize that memory chip 12 of FIG. 1 is simplified to illustrate one embodiment of a memory chip and is not intended to be a detailed illustration of all of the features of a typical memory chip. Numerous peripheral devices or circuits may be typically provided along with the memory chip 12 for writing data to and reading data from the memory cells 26. However, these peripheral devices or circuits are not shown individually in FIG. 1 for the sake of clarity.

The memory chip 12 may include a plurality of memory cells 22 generally arranged in an array of rows and columns. A row decode circuit 24 and a column decode circuit 26 may select the rows and columns, respectively, in the array in response to decoding an address provided on the address bus 17. Data to/from the memory cells 22 are then transferred over the data bus 18 via sense amplifiers and a data output path (not shown in FIG. 1). A memory controller (not shown) may provide relevant control signals (not shown) on the control bus 19 to control data communication to and from the memory chip 12 via an I/O (input/output) circuit 28. The I/O circuit 28 may include a number of data output buffers or output drivers to receive the data bits from the memory cells 22 and provide those data bits or data signals to the corresponding data lines in the data bus 18. The I/O circuit 28 may also include various memory input buffers and control circuits that interact with the row and column decoders 24, 26, respectively, to select the memory cells for data read/write operations.

A memory controller (not shown) may determine the modes of operation of memory chip 12. Some examples of the input signals or control signals (not shown in FIG. 1) on the control bus 19 include an External Clock (CLK) signal, a Chip Select (CS) signal, a Row Address Strobe (RAS) signal, a Column Address Strobe (CAS) signal, a Write Enable (WE) signal, etc. The memory chip 12 communicates to other devices connected thereto via the pins 14 on the chip 12. These pins, as mentioned before, may be connected to appropriate address, data and control lines to carry out data transfer (i.e., data transmission and reception) operations.

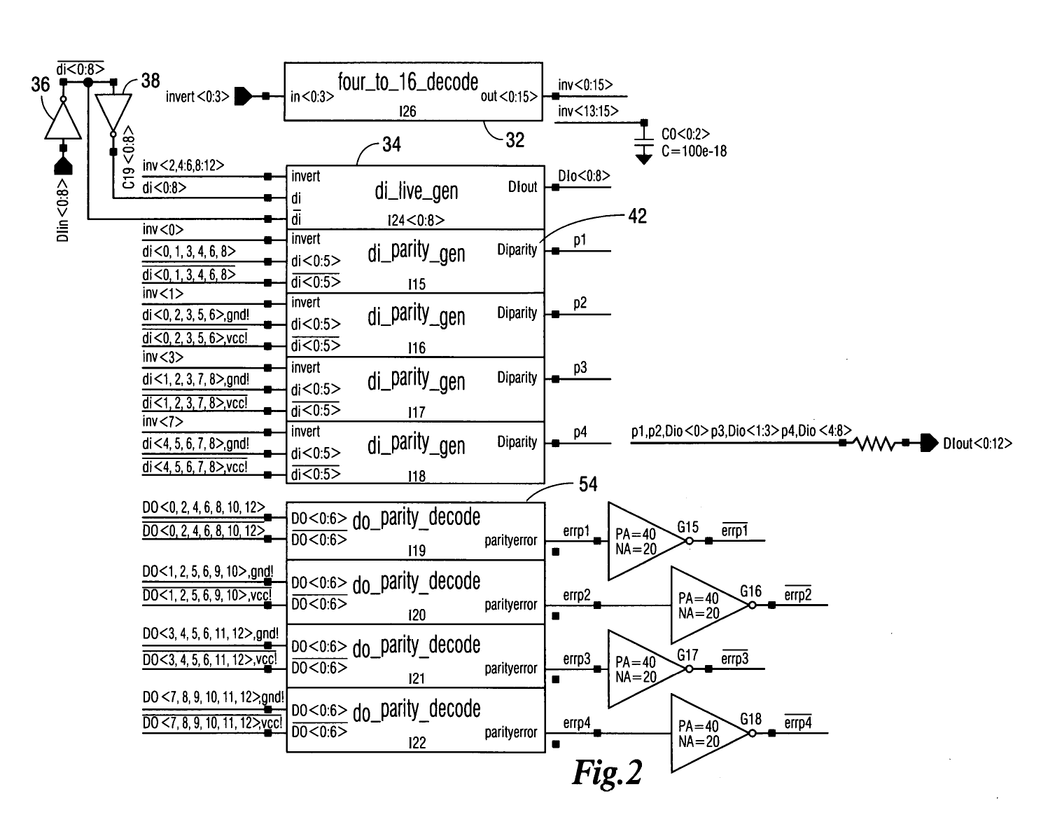

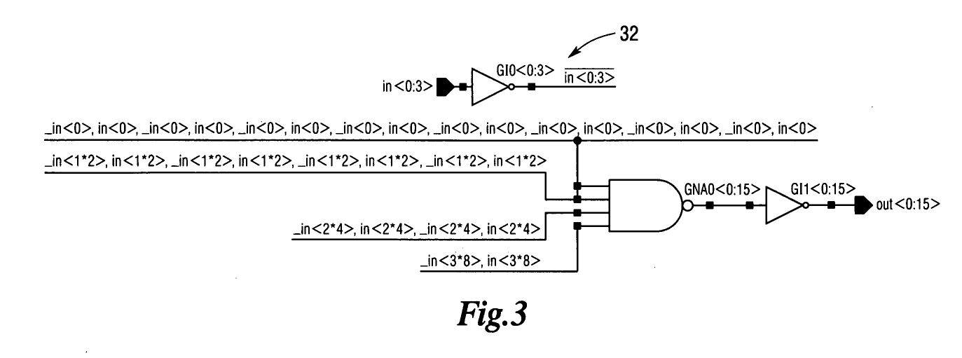

FIG. 2 is a schematic diagram illustrating a combination of circuits according to one aspect of the present invention which may be located, for example, within the I/O unit 28. The combination shown in FIG. 2 includes a decode circuit 32. The decode circuit 32, in this example, receives a four bit signal and decodes it to identify a bit which is to be flipped to force an error into a received data or test pattern as will be described more fully below. Details of one embodiment of a decode circuit 32 are shown in FIG. 3 although any type of decode circuit may be employed. Assuming there is sufficient bandwidth, the identification of the bit to be flipped could simply be received and used by the combination shown in FIG. 2 thus eliminating the decode circuit 32.

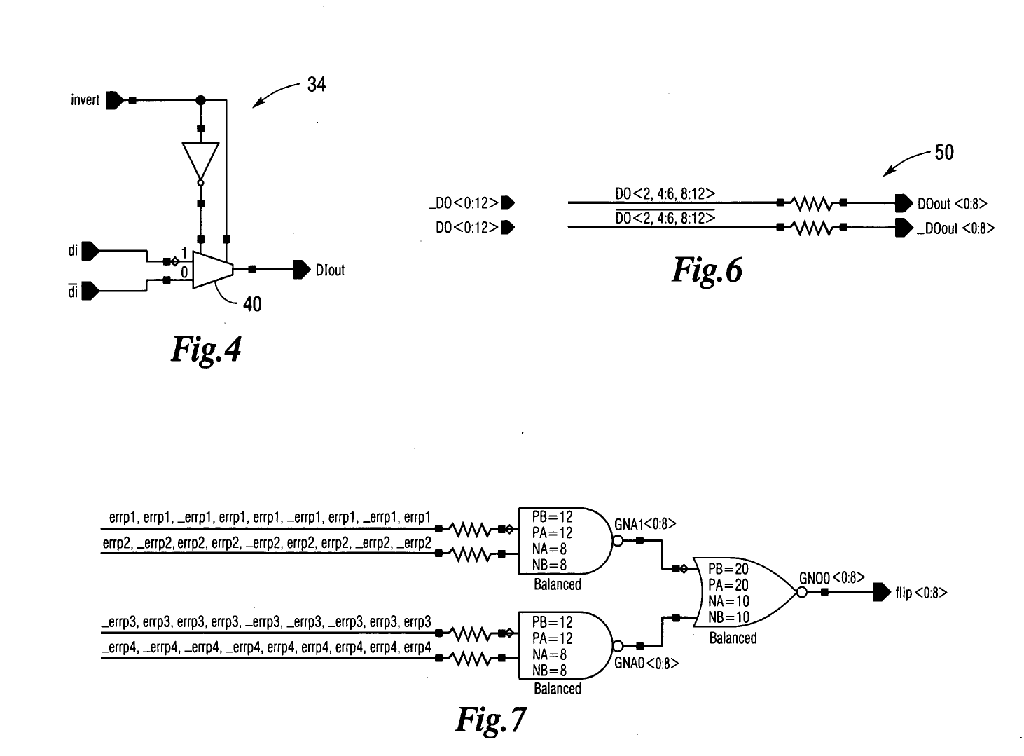

Returning to FIG. 2, the next circuit in the combination is circuit 34, labeled di live generator. Circuit 34 is connected to a pair of input amplifiers 36, 38 connected as unity gained inverters. The amplifiers 36, 38 receive a test pattern, or test data and provide that data and the inverse of that data to the di live generator 34. An example of generator 34 is shown in FIG. 4.

In FIG. 4, the generator 34 is shown as including, in this example, a mux 40. The mux 40 receives the test data and the inverse of the test data and is responsive to an invert signal for selecting either the test data or the inverse of the test data to be output. The invert signal is produced by the decode circuit 32. Thus, the decode circuit 32 receives a 4 bit signal which indicates the bit position in a 16 bit signal that is to be inverted. An appropriate signal is output from decode circuit 32 to generator 34 to operate mux 40 so that only the bit in the desire position of the 16 bit signal is inverted (flipped). In that manner, the test data is manipulated to produce a predetermined error. By cycling through all of the positions within the data signal, errors can be forced in each of the positions. Depending upon the power of the error correcting ability of the memory device 12, it may be possible to force multiple errors within the test data.

The next circuit within the combination shown in FIG. 2 is the di parity generator 42, an example of which is illustrated in FIG. 5. The example shown in FIG. 5 is of a known design and therefore not further described, except to note that the generater 42 includes a mux 44 responsive to the invert signal such that the parity bits may be flipped. Four such parity generators are used in the combination of FIG. 2. The four parity bit generators 42 generate four parity bits, P1, P2, P3 and P4. In the example shown, a 13 bit hamming code is implemented. The data bits are 2, 4, 5, 6, 8, 9, 10, 11 and 12 and the parity bits are 0, 1, 3 and 7. The parity bits are chosen such that the total number of ones in each group is even as shown by the following table.

| | | | | | | | | | | | | | |
|---|---|---|---|---|---|---|---|---|---|---|---|---|---|
| Array | Ø | 1 | 2 | 3 | 4 | 5 | 6 | 7 | 8 | 9 | 1Ø | 11 | 12 |
| bits | | | | | | | | | | | | | |
| External | | | Ø | | 1 | 2 | 3 | | 4 | 5 | 6 | 7 | 8 |
| bits | | | | | | | | | | | | | |
| Parity | P1 | P2 | | P3 | | | | P4 | | | | | |
| bits | | | | | | | | | | | | | |
| P1 | X | | X | | X | | X | | X | | X | | X |
| P2 | | X | X | | | X | X | | | X | X | | |
| P3 | | | | X | X | X | X | | | | | X | X |
| P4 | | | | | | | | X | X | X | X | X | X |

As previously mentioned, the power of the error correcting circuitry will determine the errors which will be forced. More particularly, all possible errors will be forced, not only in the test data but in the error correction data as well, such that the error requiring the most time to correct can be identified, and the part characterized according to that worst case.

Returning to FIG. 2, the data produced by the generator 34 as well as the parity bits produced by the four generators 42 are written to a data array, such as the array of memory cells 22 shown in FIG. 1, using peripheral devices known in the art for writing data.

After the data has been written, the data may be read using peripheral devices known in the art. The read data may be directly output through a data output path 50 as shown in FIG. 6.

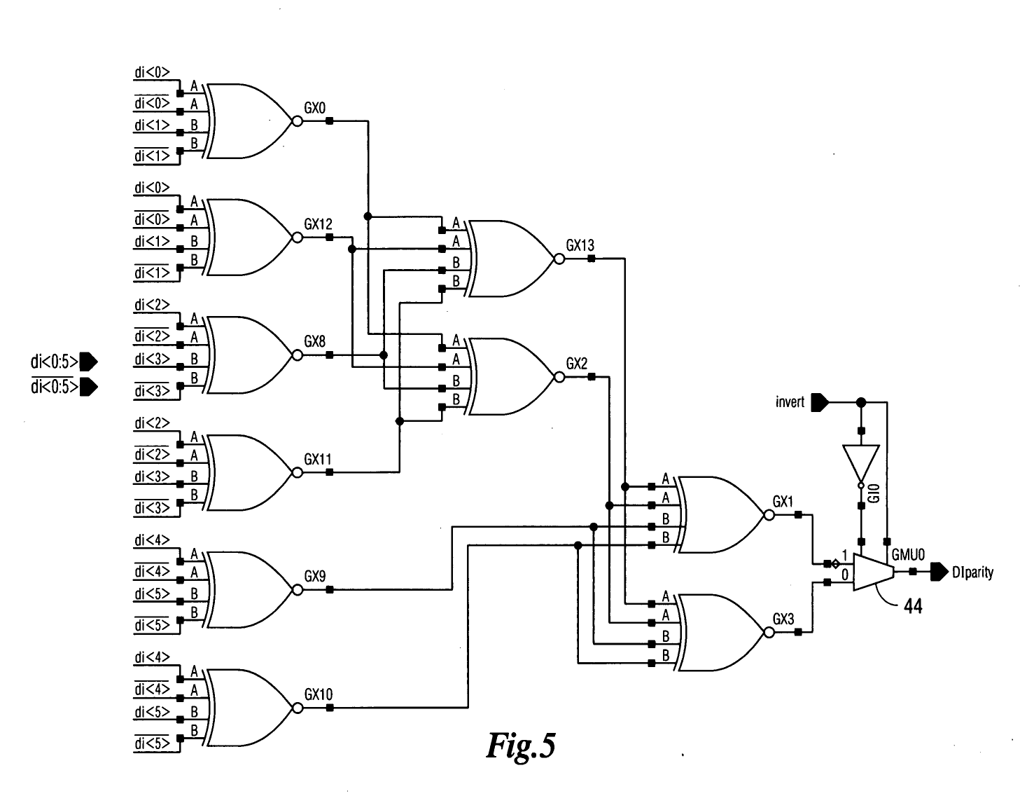

Returning to FIG. 2, the read data may also be input to a plurality, in this case four, parity decode circuits 54. The parity decode circuits 54 operate in a conventional manner to produce interrupt signals, 1, 2, 3, and 4, which are combined as shown in FIG. 7 to produce a “flip” signal. Thus, for each data bit that is read, if the bit is correct, no flip signal is generated. However, if the bit is incorrect, i.e. it has been flipped by the di live generator 34, the error correction circuitry will identify that error, and cause that bit to be flipped again. After error correction, the corrected data is then output. Circuitry, external to the memory device in this embodiment, measures the access time of the memory device. As the device cycles through each of the various data patterns with different forced errors, the memory device can be characterized for all possible combinations of corrected and uncorrected data.

The combination illustrated in FIG. 2 may be operated according to several different methods depending upon the amount of circuitry on board the memory device. For example, the decode circuit 32 could be eliminated, and that information sent to the memory device from a testing device. Additionally, assuming sufficient bandwidth and time, multiple sets of data could be sent to the memory device, with each set containing one or more forced errors. Alternatively, and as previously discussed, those functions could be performed on board given the circuitry shown in FIG. 2. Additionally, various other types of error correction, other than the generation of the four parity bits shown in FIG. 2, may be implemented. After the test data and error correction data are written into the array, the data is then read from the array, with one version of the read data being output and another version of the read data being input to the parity decode circuits 54. After the parity decode circuits 54 have determined if any errors are present, and corrected those errors, the corrected data is then output.

In summary, any individual bit being written can be “flipped”, to mimic an error, by forcing the encoded signals invert <0:3> to a state corresponding to the bit desired to be flipped. Invert <0:3> is decoded to inv <0:15>. By the nature of the 4 to 16 decode, only one bit of inv <0:15> can be asserted at any given time. Any inv <0:12> bit that is asserted will cause the corresponding bit, data or parity, to be written opposite from that which would normally be expected. That allows any error to be forced while writing standard data patterns. Invert <0:3> can be left at all ones in the default case, because inv <15> is unused, that will not flip any of the bits. This disclosure makes it possible to mimic all possible combinations of errors in data words so that the worst case scenario can be identified and tested thereby enabling the part to be characterized.

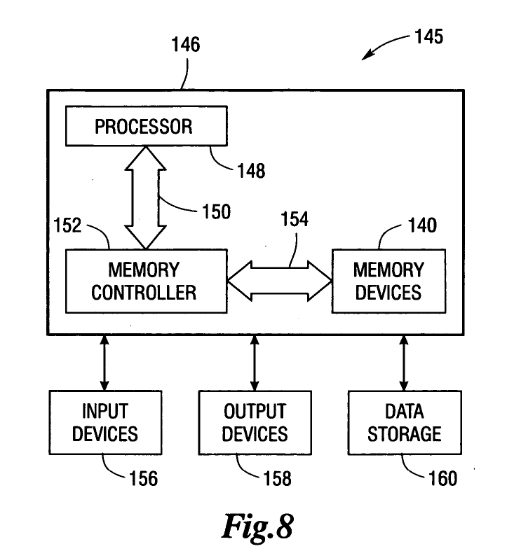

FIG. 8 is a block diagram depicting a system 145 in which one or more memory chips 140 illustrated in FIG. 1 may be used. The system 145 may include a data processing unit or computing unit 146 that includes a processor 148 for performing various computing functions, such as executing specific software to perform specific calculations or data processing tasks. The computing unit 146 also includes a memory controller 152 that is in communication with the processor 148 through a bus 150. The bus 150 may include an address bus (not shown), a data bus (not shown), and a control bus (not shown). The memory controller 152 is also in communication with a set of memory devices 140 (i.e., multiple memory chips 12 of the type shown in FIG. 1) through another bus 154 (which may be similar to the bus 14 shown in FIG. 1). Each memory device 140 may include appropriate data storage and retrieval circuitry, i.e. peripheral devices, as discussed above. The processor 148 can perform a plurality of functions based on information and data stored in the memories 140.

The memory controller 152 can be a microprocessor, digital signal processor, embedded processor, micro-controller, dedicated memory test chip, a tester platform, or the like, and may be implemented in hardware or software. The memory controller 152 may control routine data transfer operations to/from the memories 140, for example, when the memory devices 140 are part of an operational computing system 146. The memory controller 152 may reside on the same motherboard (not shown) as that carrying the memory chips 140. Various other configurations of electrical connection between the memory chips 140 and the memory controller 152 may be possible. For example, the memory controller 152 may be a remote entity communicating with the memory chips 140 via a data transfer or communications network (e.g., a LAN (local area network) of computing devices). The system 145 may include one or more input devices 156 (e.g., a keyboard or a mouse) connected to the computing unit 146 to allow a user to manually input data, instructions, etc., to operate the computing unit 146. One or more output devices 158 connected to the computing unit 146 may also be provided as part of the system 145 to display or otherwise output data generated by the processor 148. Examples of output devices 158 include printers, video terminals or video display units (VDUs). In one embodiment, the system 145 also includes one or more data storage devices 160 connected to the data processing unit 146 to allow the processor 148 to store data in or retrieve data from internal or external storage media (not shown). Examples of typical data storage devices 160 include drives that accept hard and floppy disks, CD-ROMs (compact disk read-only memories), and tape cassettes.

While the present invention has been described in connection with preferred embodiments thereof, those of ordinary skill in the art will recognize that many modifications and variations are possible. The present invention is intended to be limited only by the following claims and not by the foregoing description which is intended to set forth the presently preferred embodiment.

What is claimed is:

1. A method of forcing errors in received test data, comprising:
producing error correction data from received test data;
manipulating at least one bit of said test data or said error correction data to produce a predetermined error; and
writing said test data and said error correction data, including said predetermined error, into a memory array.

2. The method of claim 1 wherein said manipulating at least one bit of said test data or said error correction data comprises manipulating one bit at a predetermined location within a data word.

3. The method of claim 1 wherein said manipulating comprises identifying a memory location to be tested, and identifying a bit within a data word which will be written to said location.

4. The method of claim 1 additionally comprising repeating said method a plurality of times, each iteration of said method having a different predetermined error, and wherein said plurality represents all of the errors correctable by said error correction data.

5. A method of characterizing an output delay in a memory device, comprising:
reading test data and error correction data from a memory array;
outputting said read test data;
correcting said read test data using said error correction data;
outputting said corrected data; and
measuring a time delay between outputting said read test data and outputting said corrected data.

6. The method of claim 5, additionally comprising:
receiving test data;
producing error correction data from said test data;
manipulating at least one bit of said test data or said error correction data to produce a predetermined error; and
writing said test data and said error correction data, including said predetermined error, into said memory array.

7. The method of 6 wherein said manipulating at least one bit of said test data or said error correction data comprises manipulating one bit at a predetermined location within a data word.

8. The method of claim 6 wherein said manipulating comprises identifying a memory location to be tested, and identifying a bit within a data word which will be written to said location.

9. The method of claim 6 additionally comprising repeating said method a plurality of times, each iteration of said method having a different predetermined error, and wherein said plurality represents all of the errors correctable by said error correction data.

10. The method of claim 9 additionally comprising characterizing the output speed of said memory device based on said repeating of said method a plurality of times.

11. A method of operating a memory device, comprising:
writing test data and error correction data into a memory array, said data written into said array including one or more errors;
reading said written data from said array;
outputting said read test data;
correcting said read test data using said error correction data; and
outputting said corrected data.

12. The method of claim 11 additionally comprising:
receiving said test data;
producing said error correction data from said test data; and
manipulating at least one bit of said test data or said error correction data to produce a predetermined error.

13. The method of claim 12 wherein said manipulating at least one bit of said test data comprises manipulating one bit at a predetermined location within a data word.

14. The method of claim 12 wherein said manipulating comprises identifying a memory location to be tested, and identifying a bit within a data word which will be written to said location.

15. The method of claim 12 additionally comprising repeating said method a number iterations, each iteration being responsive to a different error, and wherein said plurality represents all of the errors correctable by said error correction data.

16. A combination, comprising:
a decode circuit;
an error correction data generator, responsive to test data, for producing error correction data; and
a first circuit, responsive to said decode circuit, for receiving said test data and said error correction data and for manipulating at least one bit of said received data to produce a predetermined error.

17. The combination of claim 16 wherein said first circuit is configured such that one bit in a predetermined location is manipulated within a data word.

18. The combination of claim 16 wherein said error correction data generator is configured to generate a Hamming code.

19. The combination of claim 16 additionally comprising an error correction circuit for receiving test data and error correction data read from a memory array, said error correction circuit for correcting said data read from said memory array.

20. The combination of claim 19, additionally comprising a circuit configured to measure a time delay between the outputting of said read test data and the outputting said corrected data.

21. A memory device, comprising:
an array of memory cells;
a plurality of peripheral devices for reading data from and writing data to said memory cells, said peripheral devices, comprising:
a decode circuit;
an error correction data generator, responsive to test data, for producing error correction data;
a first circuit, responsive to said decode circuit, for receiving said test data and said error correction data and for manipulating at least one bit of said received data to produce a predetermined error: and
an error correction circuit for receiving test data and error correction data read from said memory array, said error correction circuit for correcting said test data read from said memory array.

22. The device of claim 21 wherein said first circuit is configured to manipulate one bit at a predetermined location within a data word.

23. The device of claim 21 wherein said error correction data generator is configured to generate a Hamming code.

24. A system, comprising:
a processor;
a bus;
a memory device connected to said processor through said bus, said memory device comprising an array of memory cells and a plurality of peripheral devices for reading data from and writing data to said memory cells, said peripheral devices, comprising:
a decode circuit;
an error correction data generator, responsive to test data, for producing error correction data;
a first circuit, responsive to said decode circuit, for receiving said test data and said error correction data and for manipulating at least one bit of said received data to produce a predetermined error: and
an error correction circuit for receiving test data and error correction data read from said memory array, said error correction circuit for correcting said test data read from said memory array.

25. The system of claim 24 wherein said first circuit is configured to manipulate one bit at a predetermined location within a data word.

26. The system of claim 24 wherein said error correction data generator is configured to generate a Hamming code.
